(19) United States
(12) Patent Application Publication
(10) Pub. No.: US 2021/0032503 A1
(43) Pub. Date: Feb. 4, 2021

(54) DOUBLE-SIDED PRESSURE-SENSITIVE ADHESIVE TAPE

(71) Applicant: NITTO DENKO CORPORATION, Osaka (JP)

(72) Inventors: Takuya FUJITA, Ibaraki-shi (JP); Naohiro KATO, Ibaraki-shi (JP); Masahito NIWA, Ibaraki-shi (JP); Yasushi BUZOJIMA, Ibaraki-shi (JP)

(73) Assignee: NITTO DENKO CORPORATION, Osaka (JP)

(21) Appl. No.: 16/921,326

(22) Filed: Jul. 6, 2020

(30) Foreign Application Priority Data
Aug. 1, 2019 (JP) 2019-142244

(51) Int. Cl. C09J 7/38; C09J 11/08; C09J 133/10

(52) U.S. Cl. CPC C09J 7/38; C09J 11/08; C09J 2203/326; C09J 2301/124; C09J 133/10

(57) ABSTRACT

Provided is a double-sided pressure-sensitive adhesive tape that can express excellent impact resistance. The double-sided pressure-sensitive adhesive tape is a double-sided pressure-sensitive adhesive tape for use in fixing a member to be included in a mobile device, the double-sided pressure-sensitive adhesive tape including a pressure-sensitive adhesive layer, wherein the pressure-sensitive adhesive layer is formed from a pressure-sensitive adhesive composition, and wherein the pressure-sensitive adhesive composition contains an organic hollow filler.

This application claims priority under 35 U.S.C. Section 119 to Japanese Patent Application No. 2019-142244 filed on Aug. 1, 2019, which is herein incorporated by references.

### BACKGROUND OF THE INVENTION

### 1. Field of the Invention

The present invention relates to a double-sided pressure-sensitive adhesive tape.

### 2. Description of the Related Art

In recent years, along with a trend of the sophistication of various kinds of performance of a mobile device, the sophistication of various kinds of performance of various constituent members adopted in the mobile device has been required. In the mobile device, a double-sided pressure-sensitive adhesive tape is sometimes adopted for the bonding of a housing or the like. The sophistication of various kinds of performance of the double-sided pressure-sensitive adhesive tape has also been required in recent years.

There is a risk in that the mobile device falls depending on its use form. Accordingly, a mobile device having high impact resistance has been required. An impact-absorbing member is sometimes arranged outside the housing of the mobile device for improving the impact resistance of the mobile device. However, in such form, the size of the mobile device may increase or its design property may be impaired.

In view of the foregoing, it is desired that excellent impact resistance be imparted to the double-sided pressure-sensitive adhesive tape that may be arranged in the mobile device.

A double-sided pressure-sensitive adhesive sheet having impact resistance has recently been reported (Japanese Patent Application Laid-open No. 2015-120876). The double-sided pressure-sensitive adhesive sheet includes a base material made of a foam as an essential component for expressing the impact resistance. However, when the foam is extended to a certain extent or more, or a force is applied thereto, the foam is cut to have a smaller area or to become thinner. As a result, there is a problem in that the cell portions of the foam occupy a large part of an adhesion portion between the sheet and an adherend to reduce an adhesive property therebetween.

### SUMMARY OF THE INVENTION

An object of the present invention is to provide a double-sided pressure-sensitive adhesive tape that can express excellent impact resistance.

According to at least one embodiment of the present invention, there is provided a double-sided pressure-sensitive adhesive tape for use in fixing a member to be included in a mobile device, the double-sided pressure-sensitive adhesive tape including a pressure-sensitive adhesive layer, wherein the pressure-sensitive adhesive layer is formed from a pressure-sensitive adhesive composition, and wherein the pressure-sensitive adhesive composition contains an organic hollow filler.

In at least one embodiment of the present invention, the organic hollow filler has a specific gravity of from 0.01 to 1.2.

In at least one embodiment of the present invention, the organic hollow filler has an average particle diameter of from 5 μm to 70 μm.

In at least one embodiment of the present invention, the organic hollow filler is an acrylonitrile-based hollow filler.

In at least one embodiment of the present invention, the double-sided pressure-sensitive adhesive tape has a thickness of 100 μm or more.

In at least one embodiment of the present invention, the pressure-sensitive adhesive composition contains at least one kind selected from a monomer component (m) and a polymer component (P) obtained by polymerizing the monomer component (m), and the monomer component (m) contains an alkyl (meth)acrylate having an alkyl group having 4 to 18 carbon atoms at an ester terminal thereof.

In at least one embodiment of the present invention, a content of the alkyl (meth)acrylate having an alkyl group having 4 to 18 carbon atoms at an ester terminal thereof in the monomer component (m) is from 50 wt % to 100 wt %.

In at least one embodiment of the present invention, the double-sided pressure-sensitive adhesive tape is used in fixing one of a display portion and a display portion-protecting member with respect to a housing in the mobile device.

### BRIEF DESCRIPTION OF THE DRAWINGS

FIG. 1 is a schematic sectional view of a double-sided pressure-sensitive adhesive tape according to at least one embodiment of the present invention.

FIG. 2 is a photographic view of a section of a double-sided pressure-sensitive adhesive tape (1), which was obtained in Example 1, taken with a scanning electron microscope (S-3400N manufactured by Hitachi High-Technologies Corporation).

### DESCRIPTION OF THE EMBODIMENTS

As used herein, the term “(meth)acryl” means at least one kind selected from an acryl and a methacryl, and the term “(meth)acrylate” means at least one kind selected from an acrylate and a methacrylate.

<<A. Double-sided Pressure-sensitive Adhesive Tape>>

A double-sided pressure-sensitive adhesive tape according to at least one embodiment of the present invention includes a pressure-sensitive adhesive layer.

The pressure-sensitive adhesive layer may be a single-layer pressure-sensitive adhesive layer formed only of one pressure-sensitive adhesive layer, or may be a pressure-sensitive adhesive layer laminate obtained by laminating “n” or more pressure-sensitive adhesive layers.

Symbol “n” represents an integer of 2 or more, preferably an integer of from 2 to 5, more preferably an integer of from 2 to 4, still more preferably an integer of 2 or 3.

The double-sided pressure-sensitive adhesive tape according to at least one embodiment of the present invention preferably includes the pressure-sensitive adhesive layer laminate obtained by laminating the “n” or more pressure-sensitive adhesive layers because the tape can express more excellent impact resistance.

The double-sided pressure-sensitive adhesive tape according to at least one embodiment of the present invention preferably includes the pressure-sensitive adhesive layer laminate having (n−1) interfaces. The interfaces objectively show that the pressure-sensitive adhesive layer laminate is formed by laminating the “n” or more pressure-sensitive adhesive layers. The interfaces may be observed by, for example, the differential interferometry of LEXT OLS 4000 manufactured by Olympus Corporation.

The double-sided pressure-sensitive adhesive tape according to at least one embodiment of the present invention may include any appropriate other layer to such an extent that the effect of the present invention is not impaired as long as the tape includes the pressure-sensitive adhesive layer laminate formed by laminating the “n” or more pressure-sensitive adhesive layers. The double-sided pressure-sensitive adhesive tape according to at least one embodiment of the present invention is preferably formed of the pressure-sensitive adhesive layer laminate formed by laminating the “n” or more pressure-sensitive adhesive layers because the effect of the present invention can be further expressed.

The thickness of the double-sided pressure-sensitive adhesive tape according to at least one embodiment of the present invention is preferably 100 μm or more because the effect of the present invention can be further expressed, and the thickness is more preferably from 100 μm to 1,000 μm, still more preferably from 100 μm to 500 μm, particularly preferably from 100 μm to 300 μm.

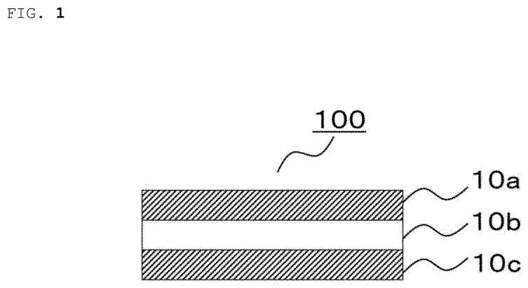

FIG. 1 is a schematic sectional view of a double-sided pressure-sensitive adhesive tape according to at least one embodiment of the present invention. In FIG. 1, a double-sided pressure-sensitive adhesive tape 100 is formed of three pressure-sensitive adhesive layers, and includes a pressure-sensitive adhesive layer 10a, a pressure-sensitive adhesive layer 10b, and a pressure-sensitive adhesive layer 10c.

Any appropriate release liner may be arranged on the surface of the pressure-sensitive adhesive layer for, for example, protecting the tape until the tape is used to such an extent that the effect of the present invention is not impaired. Examples of the release liner include: a release liner including a release-treated layer on the surface of a base material (liner base material), such as paper or a plastic film; a fluorine-based polymer (e.g., polytetrafluoroethylene); and a release liner obtained by laminating a polyolefin-based resin on the surface of a base material (liner base material), such as paper or a plastic film. Examples of the plastic film serving as the liner base material include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film. The plastic film serving as the liner base material is preferably a polyethylene film. The release-treated layer may be formed by subjecting the liner base material to a surface treatment with a release treatment agent, such as a silicone-based release treatment agent, a long-chain alkyl-based release treatment agent, a fluorine-based release treatment agent, or molybdenum sulfide.

The thickness of the release liner is preferably from 1 μm to 500 μm, more preferably from 3 μm to 450 μm, still more preferably from 5 μm to 400 μm, particularly preferably from 10 μm to 300 μm.

The pressure-sensitive adhesive strength of the double-sided pressure-sensitive adhesive tape according to at least one embodiment of the present invention is preferably from 5 N/10 mm to 50 N/10 mm, more preferably from 6 N/10 mm to 40 N/10 mm, still more preferably from 7 N/10 mm to 30 N/10 mm, particularly preferably from 8 N/10 mm to 20 N/10 mm. When the pressure-sensitive adhesive strength of the double-sided pressure-sensitive adhesive tape according to at least one embodiment of the present invention falls within the range, a function as a double-sided pressure-sensitive adhesive tape can be sufficiently expressed.

<A-1. Pressure-Sensitive Adhesive Layer Laminate>

The double-sided pressure-sensitive adhesive tape according to at least one embodiment of the present invention may include the pressure-sensitive adhesive layer laminate. The pressure-sensitive adhesive layer laminate is formed by laminating the “n” or more pressure-sensitive adhesive layers.

All of the “n” respective pressure-sensitive adhesive layers forming the pressure-sensitive adhesive layer laminate may be pressure-sensitive adhesive layers having the same composition, or at least one of the layers may be a pressure-sensitive adhesive layer different from the other layers in composition.

The thickness of the pressure-sensitive adhesive layer laminate is preferably 100 μm or more because the effect of the present invention can be further expressed, and the thickness is more preferably from 100 μm to 1,000 μm, still more preferably from 100 μm to 500 μm, particularly preferably from 100 μm to 300 μm.

<A-2. Pressure-Sensitive Adhesive Layers>

Each of the pressure-sensitive adhesive layers includes a pressure-sensitive adhesive. Any appropriate pressure-sensitive adhesive may be adopted as the kind of the pressure-sensitive adhesive forming the pressure-sensitive adhesive layer to the extent that the effect of the present invention is not impaired. Such pressure-sensitive adhesive may be a pressure-sensitive adhesive formed from a pressure-sensitive adhesive composition containing, as base polymers (main components among polymer components, that is, components accounting for 50 wt % or more of the composition), one or two or more kinds selected from the group consisting of various polymers (pressure-sensitive adhesive polymers), such as an acrylic polymer, a polyester-based polymer, a urethane-based polymer, a polyether-based polymer, a rubber-based polymer, a silicone-based polymer, a polyamide-based polymer, and a fluorine-based polymer.

Each of the pressure-sensitive adhesive layers is formed from the pressure-sensitive adhesive composition.

Each of the pressure-sensitive adhesive layers is formed from the pressure-sensitive adhesive composition by any appropriate method. Examples of such method include: a method (direct method) involving applying the pressure-sensitive adhesive composition serving as a formation material for the pressure-sensitive adhesive layers onto any appropriate base material (e.g., a base material film), and drying the composition as required, to form the pressure-sensitive adhesive layers on the base material; and a method (transfer method) involving applying the pressure-sensitive adhesive composition to a surface having releasability (release surface), and drying the composition as required, to form the pressure-sensitive adhesive layers on the surface having releasability (release surface), and transferring the pressure-sensitive adhesive layers onto any appropriate base material (e.g., a base material film). The surface having releasability (release surface) is, for example, the surface of the release liner described in the foregoing.

Any appropriate application method may be adopted as a method of applying the pressure-sensitive adhesive composition to such an extent that the effect of the present invention is not impaired. Examples of such application method include roll coating, gravure coating, reverse coating, roll brushing, spray coating, an air knife coating method, and extrusion coating with a die coater or the like. Active energy ray irradiation, such as UV irradiation, may be performed for curing an applied layer formed by the application.

The drying of the pressure-sensitive adhesive composition may be performed under heating from the viewpoints of, for example, the acceleration of the cross-linking reaction of the composition and an improvement in production efficiency of the tape. A drying temperature may be typically set to, for example, from 40° C. to 150° C., and is preferably from 60° C. to 130° C. After the drying of the pressure-sensitive adhesive composition, aging may be further performed for the purposes of, for example, adjusting the migration of a component in the pressure-sensitive adhesive layer, advancing the cross-linking reaction, and alleviating strain that may be present in the pressure-sensitive adhesive layer.

The thickness of each of the pressure-sensitive adhesive layers may be appropriately set in accordance with the thickness of the pressure-sensitive adhesive layer laminate to be finally formed and the number of the pressure-sensitive adhesive layers. Such thickness of each of the pressure-sensitive adhesive layers is preferably from 10 μm to 1,000 μm, more preferably from 20 μm to 700 μm, still more preferably from 30 μm to 500 μm, particularly preferably from 40 μm to 300 μm, most preferably from 50 μm to 200 μm.

The light transmittance of each of the pressure-sensitive adhesive layers in each of an XY direction and a Z direction is preferably 5% or less, more preferably 3% or less, still more preferably 1% or less, still further more preferably 0.5% or less, particularly preferably 0.1% or less, most preferably 0.04% or less. When the light transmittance of each of the pressure-sensitive adhesive layers in each of the XY direction and the Z direction falls within the range, the pressure-sensitive adhesive layers can express excellent light-shielding properties. The light transmittance of each of the pressure-sensitive adhesive layers in the XY direction is preferably 0.03% or less, more preferably 0.02% or less, still more preferably 0.01% or less. The light transmittance of each of the pressure-sensitive adhesive layers in the Z direction is preferably 0.03% or less, more preferably 0.02% or less, still more preferably 0.01% or less.

<A-2-1. Pressure-Sensitive Adhesive Composition>

The pressure-sensitive adhesive composition contains an organic hollow filler. The number of kinds of the organic hollow fillers in the pressure-sensitive adhesive composition may be only one, or may be two or more. When the pressure-sensitive adhesive composition contains the organic hollow filler, a double-sided pressure-sensitive adhesive tape that can express excellent impact resistance can be provided.

The pressure-sensitive adhesive composition preferably contains at least one kind selected from a monomer component (m) and a polymer component (P) obtained by the polymerization of the monomer component (m). That is, typically, the pressure-sensitive adhesive composition may preferably have any one of the following forms: a form that contains the polymer component (P) and is substantially free of the monomer component (m) (form 1); a form that contains the monomer component (m) and is substantially free of the polymer component (P) (form 2); and a form that contains both of the monomer component (m) and the polymer component (P) (form 3).

The form that contains the polymer component (P) and is substantially free of the monomer component (m) (form 1) is a form in which, at the stage of the preparation of the pressure-sensitive adhesive composition, the polymer component (P) is substantially formed by the polymerization of the monomer component (m).

The form that contains the monomer component (m) and is substantially free of the polymer component (P) (form 2) is a form in which, at the stage of the preparation of the pressure-sensitive adhesive composition, substantially no polymerization of the monomer component (m) occurs, and hence the polymer component (P) has not been formed yet. In the form, the polymer component (P) may be formed by, for example, curing the applied layer formed by the application of the prepared pressure-sensitive adhesive composition through active energy ray irradiation, such as UV irradiation.

The form that contains both of the monomer component (m) and the polymer component (P) (form 3) is a form in which, at the stage of the preparation of the pressure-sensitive adhesive composition, part of the molecules of the monomer component (m) are polymerized to form a partial polymer, and the molecules of the monomer component (m) that are unreacted remain. In the form, the polymer component (P) may be formed by, for example, curing the applied layer formed by the application of the prepared pressure-sensitive adhesive composition through active energy ray irradiation, such as UV irradiation.

In the case of the form 1 (form that contains the polymer component (P) and is substantially free of the monomer component (m)), the content of the polymer component (P) in the pressure-sensitive adhesive composition is as follows: when the total amount of the pressure-sensitive adhesive composition is set to 100 parts by weight, the content of the polymer component (P) is preferably from 50 wt % to 100 wt %, more preferably from 60 wt % to 100 wt %, still more preferably from 70 wt % to 100 wt %, particularly preferably from 80 wt % to 100 wt %.

In the case of the form 2 (form that contains the monomer component (m) and is substantially free of the polymer component (P)), the content of the monomer component (m) in the pressure-sensitive adhesive composition is as follows: when the total amount of the pressure-sensitive adhesive composition is set to 100 parts by weight, the content of the monomer component (m) is preferably from 50 wt % to 100 wt %, more preferably from 60 wt % to 100 wt %, still more preferably from 70 wt % to 100 wt %, particularly preferably from 80 wt % to 100 wt %.

In the case of the form 3 (form that contains both of the monomer component (m) and the polymer component (P)), the total content of the polymer component (P) and the monomer component (m) in the pressure-sensitive adhesive composition is as follows: when the total amount of the pressure-sensitive adhesive composition is set to 100 parts by weight, the total content of the polymer component (P) and the monomer component (m) is preferably from 50 wt % to 100 wt %, more preferably from 60 wt % to 100 wt %, still more preferably from 70 wt % to 100 wt %, particularly preferably from 80 wt % to 100 wt %.

The pressure-sensitive adhesive composition may contain any appropriate colorant from the viewpoint of, for example, adjusting its light transmissivity (light-shielding property) to such an extent that the effect of the present invention is not impaired. A conventionally known pigment or dye may be used as such colorant. Examples of the pigment include: inorganic pigments, such as carbon black, zinc carbonate, zinc oxide, zinc sulfide, talc, kaolin, calcium carbonate, titanium oxide, silica, lithium fluoride, calcium fluoride, barium sulfate, alumina, zirconia, an iron oxide-based pigment, an iron hydroxide-based pigment, a chromium oxide-based pigment, a spinel-type calcined pigment, a chromic acid-based pigment, a chrome vermilion-based pigment, an iron blue-based pigment, an aluminum powder-based pigment, a bronze powder-based pigment, a silver powder-based pigment, and calcium phosphate; and organic pigments, such as a phthalocyanine-based pigment, an azo-based pigment, a condensed azo-based pigment, an azo lake-based pigment, an anthraquinone-based pigment, a perylene-perinone-based pigment, an indigo-based pigment, a thioindigo-based pigment, an isoindolinone-based pigment, an azomethine-based pigment, a dioxazine-based pigment, a quinacridone-based pigment, an aniline black-based pigment, and a triphenylmethane-based pigment. Examples of the dye include an azo-based dye, anthraquinone, quinophthalone, a styryl-based dye, diphenylmethane, triphenylmethane, oxazine, triazine, xanthan, azomethine, acridine, and diazine. The number of kinds of the colorants may be only one, or two or more.

Specific examples of the black colorant include carbon black, graphite, copper oxide, manganese dioxide, aniline black, perylene black, titanium black, cyanine black, activated carbon, ferrite (e.g., non-magnetic ferrite or magnetic ferrite), magnetite, chromium oxide, iron oxide, molybdenum disulfide, a chromium complex, and an anthraquinone-based colorant.

The content of the colorant in the pressure-sensitive adhesive composition is preferably less than 30 wt %, more preferably less than 20 wt %, still more preferably less than 13 wt %, particularly preferably less than 10 wt %, most preferably less than 8 wt %.

The pressure-sensitive adhesive composition may contain any appropriate other component to such an extent that the effect of the present invention is not impaired. Examples of such other component include a resin component except the polymer component (P), a tackifier, a cross-linking agent, an inorganic filler, an organic filler, a metal powder, a pigment, a foil-like substance, a softener, an age resistor, a conductive agent, a UV absorber, an antioxidant, a light stabilizer, a surface lubricant, a leveling agent, a corrosion inhibitor, a heat stabilizer, a polymerization inhibitor, a lubricant, a solvent, and a catalyst.

<A-2-1-1. Organic Hollow Filler>

The pressure-sensitive adhesive composition contains the organic hollow filler. When the pressure-sensitive adhesive composition contains the organic hollow filler, a double-sided pressure-sensitive adhesive tape that can express excellent impact resistance can be provided.

The number of kinds of the organic hollow fillers may be only one, or may be two or more.

The organic hollow filler is an organic filler having a hollow structure, and is typically, for example, at least one kind selected from an organic hollow filler, and an organic-inorganic hybrid-type hollow filler formed of an organic and inorganic composite material.

The organic hollow filler is a hollow filler including organic matter, and is typically a hollow filler including a polymer. Examples of a monomer to be used for forming such polymer include acrylonitrile, vinyl chloride, vinylidene chloride, styrene, vinyl acetate, and a (meth)acrylate. The organic hollow filler includes organic matter as a main component (at a weight ratio of preferably 50 wt % or more), and in addition, the surface thereof may be coated with powder (e.g., calcium carbonate, talc, or titanium oxide).

In a preferred embodiment of the present invention, the polymer forming the organic hollow filler is preferably one of a polymer obtained from monomers including an acrylate (acrylate-based polymer) and a polymer obtained from monomers including acrylonitrile (acrylonitrile-based polymer) because the effect of the present invention can be further expressed, and the polymer is more preferably the polymer obtained from the monomers including acrylonitrile (acrylonitrile-based polymer). That is, in a preferred embodiment of the present invention, the organic hollow filler is preferably a hollow filler including the acrylonitrile-based polymer (acrylonitrile-based hollow filler) because the effect of the present invention can be further expressed.

Examples of the hollow filler formed of acrylonitrile include MATSUMOTO MICROSPHERE F-35, MATSUMOTO MICROSPHERE F-65, MATSUMOTO MICROSPHERE FN-80SDE, and MATSUMOTO MICROSPHERE MFL-81GCA manufactured by Matsumoto Yushi-Seiyaku Co., Ltd., and Expancel 053 40 and Expancel 551 DE 40 d42 manufactured by Nouryon.

The specific gravity of the organic hollow filler is preferably from 0.01 to 1.20, more preferably from 0.02 to 1.10, still more preferably from 0.05 to 1.00, still further more preferably from 0.08 to 0.80, particularly preferably from 0.10 to 0.50, most preferably from 0.12 to 0.30 because the effect of the present invention can be further expressed.

The average particle diameter of the organic hollow filler is preferably from 5 μm to 70 μm, more preferably from 7 μm to 60 μm, still more preferably from 10 μm to 50 μm, particularly preferably from 12 μm to 40 μm, most preferably from 15 μm to 35 μm because the effect of the present invention can be further expressed.

The heat resistance of the organic hollow filler is preferably 100° C. or more, more preferably from 110° C. to 150° C., still more preferably from 115° C. to 140° C., particularly preferably from 120° C. to 140° C. because the effect of the present invention can be further expressed.

In the case of the form 1 (form that contains the polymer component (P) and is substantially free of the monomer component (m)), the content of the organic hollow filler in the pressure-sensitive adhesive composition is as follows: when the total amount of the polymer component (P) is set to 100 parts by weight, the content of the organic hollow filler is preferably from 0.05 wt % to 50 wt %, more preferably from 0.1 wt % to 40 wt %, particularly preferably from 1 wt % to 30 wt %, most preferably from 1 wt % to 20 wt %.

In the case of the form 2 (form that contains the monomer component (m) and is substantially free of the polymer component (P)), the content of the organic hollow filler in the pressure-sensitive adhesive composition is as follows: when the total amount of the monomer component (m) is set to 100 parts by weight, the content of the organic hollow filler is preferably from 0.05 wt % to 50 wt %, more preferably from 0.1 wt % to 40 wt %, particularly preferably from 1 wt % to 30 wt %, most preferably from 1 wt % to 20 wt %.

In the case of the form 3 (form that contains both of the monomer component (m) and the polymer component (P)), the content of the organic hollow filler in the pressure-sensitive adhesive composition is as follows: when the total amount of the sum of the polymer component (P) and the monomer component (m) is set to 100 parts by weight, the content of the organic hollow filler is preferably from 0.05 wt % to 50 wt %, more preferably from 0.1 wt % to 40 wt %, particularly preferably from 1 wt % to 30 wt %, most preferably from 1 wt % to 20 wt %.

<A-2-1-2. Monomer Component (m)>

Any appropriate monomer component may be adopted as the monomer component (m) to the extent that the effect of the present invention is not impaired.

The monomer component (m) preferably contains an alkyl (meth)acrylate having an alkyl group having 4 to 18 carbon atoms at an ester terminal thereof. The number of kinds of the alkyl (meth)acrylates each having an alkyl group having 4 to 18 carbon atoms at an ester terminal thereof may be only one, or two or more.

Specific examples of the alkyl (meth)acrylate having an alkyl group having 4 to 18 carbon atoms at an ester terminal thereof include: alkyl (meth)acrylates each having a linear alkyl group having 4 to 18 carbon atoms at an ester terminal thereof, such as n-butyl (meth)acrylate, n-pentyl (meth)acrylate, n-hexyl (meth)acrylate, n-heptyl (meth)acrylate, n-octyl (meth)acrylate, n-nonyl (meth)acrylate, n-decyl (meth)acrylate, n-undecyl (meth)acrylate, n-dodecyl (meth)acrylate, n-tridecyl (meth)acrylate, n-tetradecyl (meth)acrylate, n-pentadecyl (meth)acrylate, n-hexadecyl (meth)acrylate, n-heptadecyl (meth)acrylate, and n-octadecyl (meth)acrylate; and alkyl (meth)acrylates each having a branched alkyl group having 4 to 18 carbon atoms at an ester terminal thereof, such as t-butyl (meth)acrylate, isobutyl (meth)acrylate, isopentyl (meth)acrylate, t-pentyl (meth)acrylate, neopentyl (meth)acrylate, isohexyl (meth)acrylate, isoheptyl (meth)acrylate, 2-ethylhexyl (meth)acrylate, isooctyl (meth)acrylate, isononyl (meth)acrylate, isodecyl (meth)acrylate, 2-propylheptyl (meth)acrylate, isoundecyl (meth)acrylate, isododecyl (meth)acrylate, isotridecyl (meth)acrylate, isomyristyl (meth)acrylate, isopentadecyl (meth)acrylate, isohexadecyl (meth)acrylate, isoheptadecyl (meth)acrylate, and isostearyl (meth)acrylate. Of those alkyl (meth)acrylates each having an alkyl group having 4 to 18 carbon atoms at an ester terminal thereof, an alkyl (meth)acrylate having a linear alkyl group having 4 to 12 carbon atoms at an ester terminal thereof is preferred because more excellent impact resistance can be expressed, and an alkyl (meth)acrylate having a linear alkyl group having 4 to 8 carbon atoms at an ester terminal thereof is more preferred, and specifically, n-butyl (meth)acrylate is particularly preferred.

The content of the alkyl (meth)acrylate having an alkyl group having 4 to 18 carbon atoms at an ester terminal thereof in the monomer component (m) is preferably from 50 wt % to 100 wt %, more preferably from 70 wt % to 99.5 wt %, still more preferably from 90 wt % to 99 wt %, particularly preferably from 91 wt % to 98 wt %, most preferably from 92 wt % to 97 wt %. When the content of the alkyl (meth)acrylate having an alkyl group having 4 to 18 carbon atoms at an ester terminal thereof in the monomer component (m) falls within the range, a double-sided pressure-sensitive adhesive tape that can express more excellent impact resistance can be provided.

The monomer component (m) preferably contains (meth)acrylic acid, and more preferably contains acrylic acid. The content of (meth)acrylic acid in the total amount of the monomer component (m) is preferably from 1 wt % to 10 wt %, more preferably from 1 wt % to 8 wt %, still more preferably from 2 wt % to 7 wt %, particularly preferably from 2 wt % to 6 wt %, most preferably from 2.5 wt % to 5.5 wt %. When the content of (meth)acrylic acid in the monomer component (m) falls within the range, a double-sided pressure-sensitive adhesive tape that can express more excellent impact resistance can be provided.

The monomer component (m) may contain any other monomer. The number of kinds of such other monomers may be only one, or two or more.

The content of the other monomer in the total amount of the monomer component (m) is preferably from 0 wt % to 10 wt %, more preferably from 0 wt % to 8 wt %, still more preferably from 0 wt % to 6 wt %, particularly preferably from 0 wt % to 4 wt %, most preferably from 0 wt % to 2 wt %. When the content of the other monomer in the monomer component (m) is adjusted within the range, a double-sided pressure-sensitive adhesive tape that can express more excellent impact resistance can be provided.

Examples of the other monomer include an alicyclic structure-containing acrylic monomer, an alkyl (meth)acrylate having an alkyl group having 1 to 3 carbon atoms at an ester terminal thereof, a hydroxy group-containing monomer, a carboxyl group-containing monomer except (meth)acrylic acid, a nitrogen-based cyclic structure-containing monomer, a cyclic ether group-containing monomer, a glycol-based acrylate monomer, a styrene-based monomer, an amide group-containing monomer, an amino group-containing monomer, an imide group-containing monomer, a vinyl ether monomer, a silane-based monomer, and a polyfunctional monomer.

The alicyclic structure-containing acrylic monomer is preferably an acrylic monomer having a cyclic aliphatic hydrocarbon structure. The number of carbon atoms of the cyclic aliphatic hydrocarbon structure is preferably 3 or more, more preferably from 6 to 24, still more preferably from 6 to 18, particularly preferably from 6 to 12. Specific examples of such alicyclic structure-containing acrylic monomer include cyclopropyl (meth)acrylate, cyclobutyl (meth)acrylate, cyclopentyl (meth)acrylate, cyclohexyl (meth)acrylate, cycloheptyl (meth) acrylate, cyclooctyl (meth) acrylate, isobornyl (meth)acrylate, and dicyclopentanyl (meth)acrylate.

Specific examples of the alkyl (meth)acrylate having an alkyl group having 1 to 3 carbon atoms at an ester terminal thereof include methyl (meth)acrylate, ethyl (meth)acrylate, n-propyl (meth)acrylate, and isopropyl (meth)acrylate.

Specific examples of the hydroxy group-containing monomer include: hydroxyalkyl (meth)acrylates, such as 2-hydroxybutyl (meth) acrylate, 2-hydroxyethyl (meth) acrylate, 3-hydroxypropyl (meth) acrylate, 4-hydroxybutyl (meth) acrylate, 6-hydroxyhexyl (meth)acrylate, 8-hydroxyoctyl (meth)acrylate, 10-hydroxydecyl (meth) acrylate, and 12-hydroxylauryl (meth) acrylate; hydroxyalkylcycloalkane (meth)acrylates, such as (4-hydroxymethylcyclohexyl)methyl (meth) acrylate; and other hydroxy group-containing monomers, such as hydroxyethyl (meth)acrylamide, allyl alcohol, 2-hydroxyethyl vinyl ether, 4-hydroxybutyl vinyl ether, and diethylene glycol monovinyl ether. Of those hydroxy group-containing monomers, a hydroxyalkyl (meth)acrylate is preferred because more excellent impact resistance can be expressed, and a hydroxyalkyl (meth)acrylate having a hydroxyalkyl group having 2 to 6 carbon atoms is more preferred, and 2-hydroxyethyl (meth)acrylate or 4-hydroxybutyl (meth)acrylate is still more preferred.

Specific examples of the carboxyl group-containing monomer except (meth)acrylic acid include carboxyethyl (meth)acrylate, carboxypentyl (meth)acrylate, itaconic acid, maleic acid, fumaric acid, crotonic acid, and isocrotonic acid.

Specific examples of the nitrogen-based cyclic structure-containing monomer include: lactam-based vinyl monomers, such as N-vinylpyrrolidone, N-vinyl-ε-caprolactam, and methyl vinylpyrrolidone; vinyl-based monomers each having a nitrogen-containing heterocycle, such as vinylpyridine, vinylpiperidone, vinylpyrimidine, vinylpiperazine, vinylpyrazine, vinylpyrrole, vinylimidazole, vinyloxazole, and vinylmorpholine; and (meth)acrylic monomers each containing a heterocycle, such as a morpholine ring, a piperidine ring, a pyrrolidine ring, or a piperazine ring (e.g., N-acryloylmorpholine, N-acryloylpiperidine, N-methacryloylpiperidine, and N-acryloylpyrrolidine).

Specific examples of the cyclic ether group-containing monomer include: epoxy group-containing monomers, such as glycidyl (meth) acrylate, 3,4-epoxycyclohexylmethyl (meth)acrylate, 4-hydroxybutyl (meth)acrylate glycidyl ether, methylglycidyl (meth)acrylate, and allyl glycidyl ether; and oxetane group-containing monomers, such as 3-oxetanylmethyl (meth) acrylate, 3-methyl-oxetanylmethyl (meth) acrylate, 3-ethyl-oxetanylmethyl (meth) acrylate, 3-butyl-oxetanylmethyl (meth) acrylate, and 3-hexyl-oxetanylmethyl (meth) acrylate.

Specific examples of the glycol-based acrylate monomer include polyethylene glycol (meth)acrylate, polypropylene glycol (meth)acrylate, methoxyethylene glycol (meth)acrylate, and methoxypolypropylene glycol (meth) acrylate.

Specific examples of the styrene-based monomer include styrene and α-methylstyrene.

Specific examples of the amide group-containing monomer include acrylamide, methacrylamide, diethylacrylamide, N-vinylpyrrolidone, N,N-dimethylacrylamide, N,N-dimethylmethacrylamide, N,N-diethylacrylamide, N,N-diethylmethacrylamide, N,N′-methylenebisacrylamide, N,N-dimethylaminopropylacrylamide, N,N-dimethylaminopropylmethacrylamide, diacetone acrylamide, and N,N-hydroxyethylacrylamide.

Specific examples of the amino group-containing monomer include aminoethyl (meth) acrylate, N,N-dimethylaminoethyl (meth) acrylate, and N,N-dimethylaminopropyl (meth) acrylate.

Specific examples of the imide group-containing monomer include cyclohexyl maleimide, isopropyl maleimide, N-cyclohexyl maleimide, and itaconimide.

Specific examples of the silane-based monomer include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Specific examples of the polyfunctional monomer include: ester compounds of polyhydric alcohols and (meth)acrylic acid, such as (poly)ethylene glycol di(meth)acrylate, (poly) propylene glycol di(meth)acrylate, neopentyl glycol di(meth)acrylate, pentaerythritol di(meth)acrylate, pentaerythritol tri(meth)acrylate, dipentaerythritol penta(meth)acrylate, dipentaerythritol hexa(meth)acrylate, 1,2-ethylene glycol di(meth)acrylate, 1,6-hexanediol di(meth)acrylate, 1,12-dodecanediol di(meth)acrylate, trimethylolpropane tri(meth)acrylate, and tetramethylolmethane tri(meth)acrylate; allyl (meth)acrylate; vinyl (meth)acrylate; divinylbenzene; epoxy acrylate; polyester acrylate; urethane acrylate; butyl di(meth)acrylate; and hexyl di(meth)acrylate.

<A-2-1-3. Polymer Component (P)>

The polymer component (P) is obtained by the polymerization of the monomer component (m). The polymer component (P) is typically an acrylic polymer. The number of kinds of the polymer components (P) may be only one, or two or more.

Any appropriate production method may be adopted as a method of producing the polymer component (P) to such an extent that the effect of the present invention is not impaired. Examples of such production method include various kinds of radical polymerization including: solution polymerization; active energy ray polymerization, such as UV polymerization; bulk polymerization; and emulsion polymerization. Any appropriate polymerization conditions may be adopted as polymerization conditions to such an extent that the effect of the present invention is not impaired.

Any appropriate polymerization structure may be adopted as the polymerization structure of the polymer component (P) to be obtained to such an extent that the effect of the present invention is not impaired. Examples of such polymerization structure include a random copolymer, a block copolymer, and a graft copolymer.

Any appropriate additive may be adopted as an additive to be used in the radical polymerization, such as a polymerization initiator, a chain transfer agent, or an emulsifying agent, to such an extent that the effect of the present invention is not impaired.

A polymerization solvent that may be used in the solution polymerization or the like is, for example, ethyl acetate or toluene. The number of kinds of the polymerization solvents may be only one, or two or more.

The solution polymerization is performed in a stream of an inert gas, such as nitrogen, after the addition of a polymerization initiator typically under the reaction conditions of a temperature of from about 50° C. to about 70° C., and a time period of from about 5 hours to about 30 hours.

Any appropriate thermal polymerization initiator may be adopted as the polymerization initiator that may be used in the solution polymerization or the like to such an extent that the effect of the present invention is not impaired. The number of kinds of the polymerization initiators may be only one, or two or more. Examples of such polymerization initiator include: azo-based initiators, such as 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine) disulfate, 2,2′-azobis(N,N′-dimethyleneisobutylamidine), and 2,2′-azobis[N-(2-carboxyethyl)-2-methylpropionamidine] hydrate (VA-057, manufactured by Wako Pure Chemical Industries, Ltd.); peroxide-based initiators, such as persulfates such as potassium persulfate and ammonium persulfate, di(2-ethylhexyl) peroxydicarbonate, di(4-t-butylcyclohexyl) peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxy-2-ethylhexanoate, di(4-methylbenzoyl) peroxide, dibenzoyl peroxide, t-butyl peroxyisobutyrate, 1,1-di(t-hexylperoxy)cyclohexane, t-butyl hydroperoxide, and hydrogen peroxide; and redox-based initiators each obtained by combining a peroxide and a reducing agent, such as a combination of a persulfate and sodium hydrogen sulfite, and a combination of a peroxide and sodium ascorbate.

The usage amount of the polymerization initiator is preferably 1 part by weight or less, more preferably from 0.005 part by weight to 1 part by weight, still more preferably from 0.01 part by weight to 0.7 part by weight, particularly preferably from 0.02 part by weight to 0.5 part by weight with respect to 100 parts by weight of the total amount of the monomer component (m) because of, for example, the following reason: the polymerization reaction can be effectively advanced.

Any appropriate chain transfer agent may be adopted as the chain transfer agent to such an extent that the effect of the present invention is not impaired. The number of kinds of the chain transfer agents may be only one, or two or more. Examples of such chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol.

The usage amount of the chain transfer agent is preferably 0.1 part by weight or less with respect to 100 parts by weight of the total amount of the monomer component (m) because of, for example, the following reason: the polymerization reaction can be effectively advanced.

Any appropriate emulsifying agent may be adopted as the emulsifying agent to such an extent that the effect of the present invention is not impaired. The number of kinds of the emulsifying agents may be only one, or two or more. Examples of such emulsifying agent include: anionic emulsifying agents, such as sodium lauryl sulfate, ammonium lauryl sulfate, sodium dodecylbenzenesulfonate, an ammonium polyoxyethylene alkyl ether sulfate, and a sodium polyoxyethylene alkyl phenyl ether sulfate; and nonionic emulsifying agents, such as a polyoxyethylene alkyl ether, a polyoxyethylene alkyl phenyl ether, a polyoxyethylene fatty acid ester, and a polyoxyethylene-polyoxypropylene block polymer.

The usage amount of the emulsifying agent is preferably 5 parts by weight or less, more preferably from 0.3 part by weight to 5 parts by weight, still more preferably from 0.4 part by weight to 3 parts by weight, particularly preferably from 0.5 part by weight to 1 part by weight with respect to 100 parts by weight of the total amount of the monomer component (m) from the viewpoints of polymerization stability and mechanical stability.

When the UV polymerization is performed, a photopolymerization initiator is preferably used.

Any appropriate photopolymerization initiator may be adopted as the photopolymerization initiator to such an extent that the effect of the present invention is not impaired. The number of kinds of the photopolymerization initiators may be only one, or two or more. Examples of such photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzil-based photopolymerization initiator, a benzophenone-based photopolymerization initiator, a ketal-based photopolymerization initiator, a thioxanthone-based photopolymerization initiator, and an acylphosphine oxide-based photopolymerization initiator.

Specific examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one (e.g., a commercial product available under the product name “Irgacure 651” from BASF), and anisole methyl ether.

Specific examples of the acetophenone-based photopolymerization initiator include 1-hydroxycyclohexyl phenyl ketone (e.g., a commercial product available under the product name “Irgacure 184” from BASF), 4-phenoxydichloroacetophenone, 4-t-butyl-dichloroacetophenone, 1-[4-(2-hydroxyethoxy)-phenyl]-2-hydroxy-2-methyl-1-propan-1-one (e.g., a commercial product available under the product name “Irgacure 2959” from BASF), 2-hydroxy-2-methyl-1-phenyl-propan-1-one (e.g., a commercial product available under the product name “DAROCUR 1173” from BASF), and methoxyacetophenone.

Specific examples of the α-ketol-based photopolymerization initiator include 2-methyl-2-hydroxypropiophenone and 1-[4-(2-hydroxyethyl)-phenyl]-2-hydroxy-2-methylpropan-1-one.

A specific example of the aromatic sulfonyl chloride-based photopolymerization initiator is 2-naphthalenesulfonyl chloride.

A specific example of the photoactive oxime-based photopolymerization initiator is 1-phenyl-1,1-propanedione-2-(o-ethoxycarbonyl)-oxime.

A specific example of the benzoin-based photopolymerization initiator is benzoin.

A specific example of the benzil-based photopolymerization initiator is benzil.

Specific examples of the benzophenone-based photopolymerization initiator include benzophenone, benzoylbenzoic acid, 3,3′-dimethyl-4-methoxybenzophenone, polyvinylbenzophenone, and α-hydroxycyclohexyl phenyl ketone.

A specific example of the ketal-based photopolymerization initiator is benzyl dimethyl ketal.

Specific examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, isopropylthioxanthone, 2,4-diisopropylthioxanthone, and dodecylthioxanthone.

Specific examples of the acylphosphine-based photopolymerization initiator include bis(2,6-dimethoxybenzoyl)phenylphosphine oxide, bis(2,6-dimethoxybenzoyl) (2,4,4-trimethylpentyl)phosphine oxide, bis(2,6-dimethoxybenzoyl)-n-butylphosphine oxide, bis(2,6-dimethoxybenzoyl)-(2-methylpropan-1-yl)phosphine oxide, bis(2,6-dimethoxybenzoyl)-(1-methylpropan-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl) (2-methylpropan-1-yl)phosphine oxide, bis(2-methoxybenzoyl) (1-methylpropan-1-yl)phosphine oxide, bis(2,6-diethoxybenzoyl) (2-methylpropan-1-yl)phosphine oxide, bis(2,6-diethoxybenzoyl) (1-methylpropan-1-yl)phosphine oxide, bis(2,6-dibutoxybenzoyl) (2-methylpropan-1-yl)phosphine oxide, bis(2,4-dimethoxybenzoyl) (2-methylpropan-1-yl)phosphine oxide, bis(2,4,6-trimethylbenzoyl) (2,4-dipentoxyphenyl)phosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, bis(2,6-dimethoxybenzoyl)benzylphosphine oxide, bis(2,6-dimethoxybenzoyl)-2-phenylpropylphosphine oxide, bis(2,6-dimethoxybenzoyl)-2-phenylethylphosphine oxide, 2,6-dimethoxybenzoylbenzylbutylphosphine oxide, 2,6-dimethoxybenzoylbenzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethylbenzoyl)-2,4-di-n-butoxyphenylphosphine oxide, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide.

The usage amount of the photopolymerization initiator is preferably 5 parts by weight or less, more preferably from 0.01 part by weight to 5 parts by weight, still more preferably from 0.05 part by weight to 3 parts by weight, particularly preferably from 0.05 part by weight to 1.5 parts by weight, most preferably from 0.1 part by weight to 1 part by weight with respect to 100 parts by weight of the total amount of the monomer component (m) from the viewpoint of, for example, the expression of satisfactory polymerizability.

When the UV polymerization is performed, a polyfunctional (meth)acrylate is preferably used.

Any appropriate polyfunctional (meth)acrylate may be adopted as the polyfunctional (meth)acrylate to such an extent that the effect of the present invention is not impaired. The number of kinds of the polyfunctional (meth)acrylates may be only one, or two or more. Specific examples of such polyfunctional (meth)acrylate include: ester compounds of polyhydric alcohols and (meth)acrylic acid, such as (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol penta(meth)acrylate, dipentaerythritol hexa(meth)acrylate, 1,2-ethylene glycol di(meth)acrylate, 1,6-hexanediol di(meth)acrylate, 1,12-dodecanediol di(meth)acrylate, trimethylolpropane tri(meth)acrylate, and tetramethylolmethane tri(meth)acrylate; allyl (meth)acrylate; vinyl (meth)acrylate; divinylbenzene; epoxy acrylate; polyester acrylate; urethane acrylate; butyl di(meth)acrylate; and hexyl di(meth)acrylate.

The usage amount of the polyfunctional (meth)acrylate is preferably 5 parts by weight or less, more preferably from 0.01 part by weight to 5 parts by weight, still more preferably from 0.05 part by weight to 3 parts by weight, particularly preferably from 0.05 part by weight to 1.5 parts by weight, most preferably from 0.1 part by weight to 1 part by weight with respect to 100 parts by weight of the total amount of the monomer component (m) from the viewpoint of, for example, the expression of satisfactory cross-linkability.

Any appropriate UV polymerization method may be adopted as a method for the UV polymerization to such an extent that the effect of the present invention is not impaired. Such UV polymerization method is, for example, as follows: the monomer component (m) is compounded with the photopolymerization initiator, and as required, the polyfunctional (meth)acrylate, and the resultant is irradiated with UV light.

The weight-average molecular weight of the polymer component (P) is preferably from 100,000 to 3,000,000, more preferably from 300,000 to 2,000,000, still more preferably from 500,000 to 1,500,000, particularly preferably from 500,000 to 1,000,000 because the double-sided pressure-sensitive adhesive tape according to at least one embodiment of the present invention can express more excellent impact resistance. The weight-average molecular weight is a value measured by gel permeation chromatography (GPC) and calculated in terms of polystyrene. It may be difficult to measure the weight-average molecular weight of the polymer component (P) obtained by active energy ray polymerization.

<A-2-1-4. Tackifying Resin>

The pressure-sensitive adhesive composition may contain a tackifying resin. The number of kinds of the tackifying resins may be only one, or two or more.

Any appropriate tackifying resin may be adopted as the tackifying resin to such an extent that the effect of the present invention is not impaired. Examples of such tackifying resin include a phenol-based tackifying resin, a terpene-based tackifying resin, a modified terpene-based tackifying resin, a rosin-based tackifying resin, a hydrocarbon-based tackifying resin, an epoxy-based tackifying resin, a polyamide-based tackifying resin, an elastomer-based tackifying resin, and a ketone-based tackifying resin.

Examples of the phenol-based tackifying resin include a terpene-phenol resin, a hydrogenated terpene-phenol resin, an alkyl phenol resin, and a rosin-phenol resin. The terpene-phenol resin refers to a polymer including a terpene residue and a phenol residue, and is a concept including both of a copolymer of a terpene and a phenol compound (terpene-phenol copolymer resin) and a phenol-modified product of a homopolymer or a copolymer of a terpene (phenol-modified terpene resin). Examples of the terpene forming such terpene-phenol resin include monoterpenes, such as α-pinene, β-pinene, and limonene (including a d-form, an l-form, and a d/l-form (dipentene)). The hydrogenated terpene-phenol resin refers to a hydrogenated terpene-phenol resin having a structure obtained by hydrogenation of such terpene-phenol resin, and is sometimes referred to as hydrogenated terpene-phenol resin. The alkyl phenol resin is a resin (oil-based phenol resin) obtained from an alkyl phenol and formaldehyde. Examples of the alkyl phenol resin include novolac-type and resol-type resins. Examples of the rosin-phenol resin include phenol-modified products of rosins or various rosin derivatives (including rosin esters, unsaturated fatty acid-modified rosins, and unsaturated fatty acid-modified rosin esters). The rosin-phenol resin is, for example, a rosin-phenol resin obtained by a method involving adding phenol to the rosins or the various rosin derivatives with an acid catalyst, and thermally polymerizing the resultant.

Examples of the terpene-based tackifying resin include polymers of terpenes, such as α-pinene, β-pinene, d-limonene, l-limonene, and dipentene (typically monoterpenes). A homopolymer of one kind of terpene is, for example, an α-pinene polymer, a β-pinene polymer, or a dipentene polymer.

Examples of the modified terpene resin include a styrene-modified terpene resin and a hydrogenated terpene resin.

The concept of the rosin-based tackifying resin includes both of the rosins and rosin derivative resins. Examples of the rosins include: unmodified rosins (raw rosins), such as gum rosin, wood rosin, and tall oil rosin; and modified rosins obtained by modifying these unmodified rosins through hydrogenation, disproportionation, polymerization, or the like (e.g., a hydrogenated rosin, a disproportionated rosin, a polymerized rosin, and any other chemically modified rosin).

Examples of the rosin derivative resins include: rosin esters, such as unmodified rosin esters that are esters of the unmodified rosins and alcohols, and modified rosin esters that are esters of the modified rosins and alcohols; unsaturated fatty acid-modified rosins obtained by modifying the rosins with unsaturated fatty acids; unsaturated fatty acid-modified rosin esters obtained by modifying the rosin esters with unsaturated fatty acids; rosin alcohols obtained by subjecting carboxy groups of the rosins or the rosin derivative resins (e.g., the rosin esters, the unsaturated fatty acid-modified rosins, and the unsaturated fatty acid-modified rosin esters) to reduction treatments; and metal salts thereof. Examples of the rosin esters include methyl esters, triethylene glycol esters, glycerin esters, and pentaerythritol esters of unmodified rosins or modified rosins (e.g., a hydrogenated rosin, a disproportionated rosin, and a polymerized rosin).

Examples of the hydrocarbon-based tackifying resin include an aliphatic hydrocarbon resin, an aromatic hydrocarbon resin, an aliphatic cyclic hydrocarbon resin, an aliphatic-aromatic petroleum resin (e.g., a styrene-olefin-based copolymer), an aliphatic-alicyclic petroleum resin, a hydrogenated hydrocarbon resin, a coumarone-based resin, and a coumarone-indene-based resin.

In the case of the form 1, the content of the tackifying resin in the pressure-sensitive adhesive composition is preferably from 1 part by weight to 50 parts by weight, more preferably from 5 parts by weight to 30 parts by weight, still more preferably from 8 parts by weight to 25 parts by weight, particularly preferably from 10 parts by weight to 20 parts by weight with respect to 100 parts by weight of the polymer component (P).

In the case of the form 2, the content of the tackifying resin in the pressure-sensitive adhesive composition is preferably from 1 part by weight to 50 parts by weight, more preferably from 5 parts by weight to 30 parts by weight, still more preferably from 8 parts by weight to 25 parts by weight, particularly preferably from 10 parts by weight to 20 parts by weight with respect to 100 parts by weight of the total amount of the monomer component (m).

In the case of the form 3, the content of the tackifying resin in the pressure-sensitive adhesive composition is preferably from 1 part by weight to 50 parts by weight, more preferably from 5 parts by weight to 30 parts by weight, still more preferably from 8 parts by weight to 25 parts by weight, particularly preferably from 10 parts by weight to 20 parts by weight with respect to 100 parts by weight of the sum total amount of the polymer component (P) and the monomer component (m).

<A-2-1-5. Cross-Linking Agent>

The pressure-sensitive adhesive composition may contain a cross-linking agent. The number of kinds of the cross-linking agents may be only one, or two or more. When the pressure-sensitive adhesive composition contains the cross-linking agent, the double-sided pressure-sensitive adhesive tape according to at least one embodiment of the present invention can express excellent oil resistance in addition to excellent impact resistance.

Any appropriate cross-linking agent may be adopted as the cross-linking agent to such an extent that the effect of the present invention is not impaired. Examples of such cross-linking agent include an isocyanate-based cross-linking agent and a non-isocyanate-based cross-linking agent.

Any appropriate isocyanate-based cross-linking agent may be adopted as the isocyanate-based cross-linking agent to such an extent that the effect of the present invention is not impaired. Examples of such isocyanate-based cross-linking agent include an aromatic diisocyanate, an aliphatic diisocyanate, and an alicyclic diisocyanate, and dimers and trimers of those diisocyanates. Specific examples thereof include tolylene diisocyanate, diphenylmethane diisocyanate, hexamethylene diisocyanate, xylylene diisocyanate, hydrogenated xylylene diisocyanate, isophorone diisocyanate, hydrogenated diphenylmethane diisocyanate, 1,5-naphthylene diisocyanate, 1,3-phenylene diisocyanate, 1,4-phenylene diisocyanate, butane-1,4-diisocyanate, 2,2,4-trimethylhexamethylene diisocyanate, 2,4,4-trimethylhexamethylene diisocyanate, cyclohexane-1,4-diisocyanate, dicyclohexylmethane-4,4-diisocyanate, 1,3-bis(isocyanatomethyl)cyclohexane, methylcyclohexane diisocyanate, and m-tetramethylxylylene diisocyanate, and dimers and trimers thereof, and polyphenylmethane polyisocyanate. In addition, the trimer may be of, for example, an isocyanurate type, a biuret type, or an allophanate type.

A commercial product may be used as the isocyanate-based cross-linking agent. Examples of a commercial product of the polyisocyanate include a product available under the product name “TAKENATE 600” from Mitsui Chemicals, Inc., a product available under the product name “DURANATE TPA100” from Asahi Kasei Chemicals Corporation, and products available under the product names “CORONATE L”, “CORONATE HL”, “CORONATE HK”, “CORONATE HX”, and “CORONATE 2096” from Nippon Polyurethane Industry Co., Ltd.

Examples of the non-isocyanate-based cross-linking agent include an epoxy-based cross-linking agent, an oxazoline-based cross-linking agent, an aziridine-based cross-linking agent, a melamine-based cross-linking agent, a carbodiimide-based cross-linking agent, a hydrazine-based cross-linking agent, an amine-based cross-linking agent, a peroxide-based cross-linking agent, a metal chelate-based cross-linking agent, a metal alkoxide-based cross-linking agent, a metal salt-based cross-linking agent, and a silane coupling agent.

In one preferred embodiment, the epoxy-based cross-linking agent may be adopted as the non-isocyanate-based cross-linking agent. The epoxy-based cross-linking agent is preferably, for example, a compound having 2 or more epoxy groups in a molecule thereof, and is more preferably, for example, an epoxy-based cross-linking agent having 3 to 5 epoxy groups in a molecule thereof.

Specific examples of the epoxy-based cross-linking agent include N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether. Examples of a commercial product of the epoxy-based cross-linking agent include products available under the product names “TETRAD-C” and “TETRAD-X” from Mitsubishi Gas Chemical Company, a product available under the product name “EPICLON CR-5L” from DIC Corporation, a product available under the product name “DENACOL EX-512” from Nagase ChemteX Corporation, and a product available under the product name “TEPIC-G” from Nissan Chemical Industries, Ltd.

In the case of the form 1, the content of the cross-linking agent in the pressure-sensitive adhesive composition is preferably from 0.01 part by weight to 10 parts by weight, more preferably from 0.1 part by weight to 8 parts by weight, still more preferably from 0.5 part by weight to 7 parts by weight, particularly preferably from 1.5 parts by weight to 3.5 parts by weight with respect to 100 parts by weight of the polymer component (P). When the content of the cross-linking agent in the pressure-sensitive adhesive composition falls within the range, the double-sided pressure-sensitive adhesive tape according to at least one embodiment of the present invention can express more excellent oil resistance.

In the case of the form 2, the content of the cross-linking agent in the pressure-sensitive adhesive composition is preferably from 0.01 part by weight to 10 parts by weight, more preferably from 0.1 part by weight to 8 parts by weight, still more preferably from 0.5 part by weight to 7 parts by weight, particularly preferably from 1.5 parts by weight to 3.5 parts by weight with respect to 100 parts by weight of the total amount of the monomer component (m). When the content of the cross-linking agent in the pressure-sensitive adhesive composition falls within the range, the double-sided pressure-sensitive adhesive tape according to at least one embodiment of the present invention can express more excellent oil resistance.

In the case of the form 3, the content of the cross-linking agent in the pressure-sensitive adhesive composition is preferably from 0.01 part by weight to 10 parts by weight, more preferably from 0.1 part by weight to 8 parts by weight, still more preferably from 0.5 part by weight to 7 parts by weight, particularly preferably from 1.5 parts by weight to 3.5 parts by weight with respect to 100 parts by weight of the sum total amount of the polymer component (P) and the monomer component (m). When the content of the cross-linking agent in the pressure-sensitive adhesive composition falls within the range, the double-sided pressure-sensitive adhesive tape according to at least one embodiment of the present invention can express more excellent oil resistance.

In the pressure-sensitive adhesive composition, the isocyanate-based cross-linking agent and the non-isocyanate-based cross-linking agent (e.g., the epoxy-based cross-linking agent) may be used in combination. In this case, the ratio of the content of the non-isocyanate-based cross-linking agent in the pressure-sensitive adhesive composition to the content of the isocyanate-based cross-linking agent in the pressure-sensitive adhesive composition is preferably 1/50 or less, more preferably 1/75 or less, still more preferably 1/100 or less, particularly preferably 1/150 or less because the double-sided pressure-sensitive adhesive tape according to at least one embodiment of the present invention can express more excellent oil resistance. In addition, the ratio of the content of the non-isocyanate-based cross-linking agent in the pressure-sensitive adhesive composition to the content of the isocyanate-based cross-linking agent in the pressure-sensitive adhesive composition is preferably 1/1,000 or more, more preferably 1/500 or more because the double-sided pressure-sensitive adhesive tape according to at least one embodiment of the present invention can express more excellent oil resistance.

<A-2-1-6. Rust Inhibitor>

The pressure-sensitive adhesive composition may contain a rust inhibitor. The number of kinds of the rust inhibitors may be only one, or two or more. When the pressure-sensitive adhesive composition contains the rust inhibitor, the double-sided pressure-sensitive adhesive tape according to at least one embodiment of the present invention can express more excellent oil resistance.

Any appropriate rust inhibitor may be adopted as the rust inhibitor to such an extent that the effect of the present invention is not impaired. Such rust inhibitor is, for example, an azole-based rust inhibitor.

The azole-based rust inhibitor is preferably a rust inhibitor containing, as an effective component, an azole-based compound which is a five-membered aromatic compound containing two or more heteroatoms, and in which at least one of the heteroatoms is a nitrogen atom. Examples of such azole-based compound include: azoles, such as imidazole, pyrazole, oxazole, isoxazole, thiazole, isothiazole, selenazole, 1,2,3-triazole, 1,2,4-triazole, 1,2,5-oxadiazole, 1,3,4-oxadiazole, 1,2,3-thiadiazole, 1,2,4-thiadiazole, 1,3,4-thiadiazole, tetrazole, and 1,2,3,4-thiatriazole; derivatives thereof; amine salts thereof; and metal salts thereof.

An example of the derivative of an azole is a compound having a structure containing a fused ring of an azole ring and another ring, specifically, a benzene ring. Specific examples of the derivative of an azole include benzimidazole, benzotriazole (that is, 1,2,3-benzotriazole having a fused structure of an azole ring of 1,2,3-triazole and a benzene ring), and benzothiazole, and derivatives thereof, such as an alkylbenzotriazole (e.g., 5-methylbenzotriazole, 5-ethylbenzotriazole, 5-n-propylbenzotriazole, 5-isobutylbenzotriazole, or 4-methylbenzotriazole), an alkoxybenzotriazole (e.g., 5-methoxybenzotriazole), an alkylaminobenzotriazole, an alkylaminosulfonylbenzotriazole, mercaptobenzotriazole, hydroxybenzotriazole, nitrobenzotriazole (e.g., 4-nitrobenzotriazole), a halobenzotriazole (e.g., 5-chlorobenzotriazole), a hydroxyalkylbenzotriazole, hydrobenzotriazole, aminobenzotriazole, (substituted aminomethyl)-tolyltriazole, carboxybenzotriazole, an N-alkylbenzotriazole, bisbenzotriazole, naphthotriazole, mercaptobenzothiazole, and aminobenzothiazole, amine salts thereof, and metal salts thereof. Another example of the derivative of an azole is a derivative of an azole having a non-fused ring structure, for example, a compound having a structure containing a substituent on a non-fused azole ring, such as 3-amino-1,2,4-triazole or 5-phenyl-1H-tetrazole.

The azole-based rust inhibitor is particularly preferably, for example, a benzotriazole-based rust inhibitor containing a benzotriazole-based compound as an effective component. When the benzotriazole-based rust inhibitor containing the benzotriazole-based compound as an effective component is adopted as the azole-based rust inhibitor, the double-sided pressure-sensitive adhesive tape according to at least one embodiment of the present invention can express more excellent oil resistance.

Specific examples of the benzotriazole-based compound include 1,2,3-benzotriazole, 5-methylbenzotriazole, 4-methylbenzotriazole, and carboxybenzotriazole.

The pressure-sensitive adhesive composition may contain a rust inhibitor except the azole-based rust inhibitor. The number of kinds of the rust inhibitors except the azole-based rust inhibitor (non-azole-based rust inhibitors) may be only one, or two or more. Specific examples of such rust inhibitor except the azole-based rust inhibitor include an amine compound, a nitrite, ammonium benzoate, ammonium phthalate, ammonium stearate, ammonium palmitate, ammonium oleate, ammonium carbonate, dicyclohexylamine benzoate, urea, urotropine, thiourea, phenyl carbamate, and cyclohexylammonium-N-cyclohexyl carbamate (CHC). Examples of the amine compound include: hydroxy group-containing amine compounds, such as 2-amino-2-methyl-1-propanol, monoethanolamine, monoisopropanolamine, diethylethanolamine, ammonia, and ammonia water; cyclic amines, such as morpholine; cyclic alkylamine compounds, such as cyclohexylamine; and linear alkylamines, such as 3-methoxypropylamine. Examples of the nitrite include dicyclohexylammonium nitrite (DICHAN), diisopropylammonium nitrite (DIPAN), sodium nitrite, potassium nitrite, and calcium nitrite.

In the case of the form 1, the content of the rust inhibitor in the pressure-sensitive adhesive composition is preferably from 0.01 part by weight to 7 parts by weight, more preferably from 0.05 part by weight to 6 parts by weight, still more preferably from 0.1 part by weight to 5 parts by weight, particularly preferably from 0.3 part by weight to 4 parts by weight, most preferably from 0.5 part by weight to 3 parts by weight with respect to 100 parts by weight of the polymer component (P).

In the case of the form 2, the content of the rust inhibitor in the pressure-sensitive adhesive composition is preferably from 0.01 part by weight to 7 parts by weight, more preferably from 0.05 part by weight to 6 parts by weight, still more preferably from 0.1 part by weight to 5 parts by weight, particularly preferably from 0.3 part by weight to 4 parts by weight, most preferably from 0.5 part by weight to 3 parts by weight with respect to 100 parts by weight of the total amount of the monomer component (m).

In the case of the form 3, the content of the rust inhibitor in the pressure-sensitive adhesive composition is preferably from 0.01 part by weight to 7 parts by weight, more preferably from 0.05 part by weight to 6 parts by weight, still more preferably from 0.1 part by weight to 5 parts by weight, particularly preferably from 0.3 part by weight to 4 parts by weight, most preferably from 0.5 part by weight to 3 parts by weight with respect to 100 parts by weight of the sum total amount of the polymer component (P) and the monomer component (m).

<<B. Method of Producing Double-Sided Pressure-Sensitive Adhesive Tape>>

The double-sided pressure-sensitive adhesive tape according to at least one embodiment of the present invention may be produced by any appropriate method to such an extent that the effect of the present invention is not impaired. The following method is given as an example of such method: the respective pressure-sensitive adhesive layers are separately prepared, and are bonded to each other by any appropriate method. When a case in which the double-sided pressure-sensitive adhesive tape according to at least one embodiment of the present invention is formed of three pressure-sensitive adhesive layers is taken as an example, a method involving bonding, to both surfaces of one pressure-sensitive adhesive layer, the other two respective pressure-sensitive adhesive layers is given as an example thereof. For example, a laminator may be used in the bonding. In addition, after the bonding, aging may be performed as required under any appropriate temperature for any appropriate time period.

<<C. Typical Applications of Double-Sided Pressure-Sensitive Adhesive Tape>>

The double-sided pressure-sensitive adhesive tape according to at least one embodiment of the present invention may be adopted in any appropriate applications to the extent that the effect of the present invention is not impaired. Typical examples of such applications include mobile device applications. The mobile device is typically, for example, a mobile electronic device.

Examples of the mobile device applications include applications, such as: use in the fixing of the display portion of a mobile electronic device; use in the fixing of the display portion-protecting member of the mobile electronic device; use in the fixing of the key module member of a mobile phone (e.g., a smartphone); use in the fixing of the decoration panel of a mobile television; use in the fixing of the battery pack of a mobile personal computer; use in the waterproofing of the lens of a digital video camera; the fixing of a touch sensor; the fixing of a vibration generator; the fixing of a camera; the fixing of a battery; the fixing of a narrow member; use as a sealing agent; and the fixing of a gasket agent, such as a sealing.

A preferred example of the mobile device applications is the fixing of a member in a mobile device (preferably a mobile electronic device), and a more preferred example thereof is the fixing of a display portion or a display portion-protecting member and a housing in the mobile device (preferably the mobile electronic device).

The double-sided pressure-sensitive adhesive tape according to at least one embodiment of the present invention may be particularly preferably used in a mobile electronic device including a display portion, such as a liquid crystal display apparatus. The double-sided pressure-sensitive adhesive tape according to at least one embodiment of the present invention is suitable in, for example, an application where the display portion, such as the liquid crystal display apparatus, or a display portion-protecting member and a housing are joined to each other in such mobile electronic device.

The display portion-protecting member is typically a member having a region showing light transmissivity in its thickness direction (hereinafter sometimes referred to as “light-transmissive member”), and is sometimes referred to as “lens”. Herein, the term “lens” as used herein is a concept comprehending both of a lens that shows a light-refracting action and a lens that does not show any light-refracting action. In other words, the term “lens” as used herein comprehends a light-transmissive member free of any refracting action, such as a protective panel configured only to protect the display portion of a mobile electronic device. Such protective panel may also be grasped as a display portion-protecting member or a display portion-covering member having light transmissivity. When a material for such protective panel is glass, the protective panel may also be referred to as “cover glass”. However, a material for such protective panel or lens is not limited to glass, and only needs to be a material that can show light transmissivity.

In addition, the term “mobile electronic device” as used herein may comprehend any appropriate device as long as the device is an electronic device that can be carried and used. Herein, a state in which the device can merely be carried is not sufficient for a level required by the term “carried”, and the term means that the device has portability at such a level that an individual (standard adult) can carry the device in a relatively easy manner. Examples of the “mobile electronic device” as used herein include a mobile phone, a smartphone, a tablet-type PC, and a laptop PC. Such mobile electronic device may be a so-called wearable-type (e.g., a wristband type, such as a wrist watch type, or a head-mount type, such as a glass type) terminal. Specific examples of such mobile electronic device include: a telephone, a watch, a camera, a pair of glasses, a personal computer, and other information terminals; health care tools, such as a sphygmomanometer, a pulse rate meter, and a pedometer; and a music player, a video player, and a product having one or two or more functions, such as sound recording and video recording.

### EXAMPLES

Now, the present invention is described specifically by way of Examples. However, the present invention is by no means limited to Examples. Test and evaluation methods in Examples and the like are as described below. The term “part(s)” in the following description means “part(s) by weight” unless otherwise specified, and the term “%” in the following description means “wt %” unless otherwise specified.

<Weight-Average Molecular Weight>

A weight-average molecular weight was determined from a value in terms of standard polystyrene obtained by gel permeation chromatography (GPC). An apparatus available under the model name “HLC-8320 GPC” (column: TSKgel GMH-H(S), manufactured by Tosoh Corporation) was used as a GPC apparatus.

<Impact Resistance>

A double-sided pressure-sensitive adhesive tape sandwiched between separators was punched into a frame shape having a width of 2 mm and an outer shape of 24.5-millimeter square to provide an evaluation sample. The evaluation sample was arranged between a square stainless-steel plate having a thickness of 2 mm and an outer shape measuring 50 mm by 50 mm, the plate having a hole opened in its central portion, and a square stainless-steel plate (having an outer shape of 25 mm square and a thickness of 3 mm), and was crimped onto the plates (62 N×10 seconds) so that a force was uniformly applied to the sample in the gravity direction. After that, the resultant was left at rest under 50° C. for 2 hours and taken out. After that, the resultant was returned to an environment at 23° C. to provide a test piece. A columnar measuring stand having a length of 50 mm, an outer diameter of 49 mm, and an inner diameter of 43 mm was arranged on the pedestal of a Du Pont-type impact tester (manufactured by Toyo Seiki Seisaku-sho, Ltd.), and the test piece was mounted thereon so that the square stainless-steel plate was on a lower side. A stainless-steel impact shaft having a tip radius of 3.1 mm was mounted on the test piece, and the weight of a falling weight and its falling height were changed as follows to increase energy until the peeling of the tape occurred: when the weight was 100 g, the height was changed from 50 mm to 500 mm in increments of 50 mm; when the weight was 150 g, the height was changed from 350 mm to 500 mm in increments of 50 mm; when the weight was 200 g, the height was changed from 400 mm to 500 mm in increments of 50 mm; and when the weight was 300 g, the height was changed from 350 mm to 500 mm in increments of 50 mm. At this time, no test was performed for energy that had already been evaluated, and the load and the height were set so that the amounts of energy did not overlap each other. After that, energy immediately before the peeling was calculated from the expression “loadxheight”, and was adopted as a result.

### [Production Example 1]: Production of Pressure-Sensitive Adhesive Layer (1)

95 Parts of butyl acrylate and 5 parts of acrylic acid serving as monomer components, and 233 parts of ethyl acetate serving as a polymerization solvent were loaded into a reaction vessel including a stirring machine, a temperature gauge, a nitrogen gas-introducing tube, a reflux condenser, and a dropping funnel, and were stirred for 2 hours while a nitrogen gas was introduced into the vessel. After oxygen in the polymerization system had been removed as described above, 0.2 part of 2,2′-azobisisobutyronitrile was added as a polymerization initiator to the mixture, and the whole was subjected to solution polymerization at 60° C. for 8 hours to provide a solution of an acrylic polymer. The acrylic polymer had a weight-average molecular weight of 700,000.

20 Parts of a terpene-phenol resin (product name “YS POLYSTER T-115”, softening point: about 115° C., hydroxyl value: from 30 mgKOH/g to 60 mgKOH/g, manufactured by Yasuhara Chemical Co., Ltd.) serving as a tackifying resin, 3 parts of an isocyanate-based cross-linking agent (product name “CORONATE L”, 75% solution of a trimethylolpropane/tolylene diisocyanate trimer adduct in ethyl acetate, manufactured by Tosoh Corporation) and 0.02 part of an epoxy-based cross-linking agent (product name “TETRAD-C”, 1,3-bis(N,N-diglycidylaminomethyl)cyclohexane, manufactured by Mitsubishi Gas Chemical Company, Inc.) serving as cross-linking agents, 6 parts of a product available under the product name “ATDN101 BLACK” (manufactured by Dainichiseika Color & Chemicals Mfg. Co., Ltd.) serving as a black pigment, and 5 parts of an acrylonitrile-based hollow filler (product name “MATSUMOTO MICROSPHERE MFL-81GCA”, manufactured by Matsumoto Yushi-Seiyaku Co., Ltd., specific gravity=0.23, heat resistance=130° C., average particle diameter=20 μm) serving as an organic hollow filler with respect to 100 parts of the acrylic polymer in the resultant acrylic polymer solution were added to the solution, and the contents were stirred and mixed to prepare a pressure-sensitive adhesive composition (1).

The pressure-sensitive adhesive composition (1) was applied to the release surface of a polyester release liner having a thickness of 38 μm (product name: “DIAFOIL MRF”, manufactured by Mitsubishi Polyester Film, Inc.), and was dried at 100° C. for 2 minutes to form a pressure-sensitive adhesive layer (1) having a thickness of 100 μm.

### [Production Example 2]: Production of Pressure-Sensitive Adhesive Layer (2)

A pressure-sensitive adhesive layer (2) having a thickness of 100 μm was formed in the same manner as in Production Example 1 except that the amount of the organic hollow filler was changed to 2 parts.

### [Production Example 3]: Production of Pressure-Sensitive Adhesive Layer (3)

A pressure-sensitive adhesive layer (3) having a thickness of 100 μm was formed in the same manner as in Production Example 1 except that the amount of the organic hollow filler was changed to 0.5 part.

### [Production Example 4]: Production of Pressure-Sensitive Adhesive Layer (4)

A pressure-sensitive adhesive layer (4) having a thickness of 100 μm was formed in the same manner as in Production Example 1 except that the amount of the organic hollow filler was changed to 10 parts.

### [Production Example 5]: Production of Pressure-Sensitive Adhesive Layer (5)

A pressure-sensitive adhesive layer (5) having a thickness of 100 μm was formed in the same manner as in Production Example 1 except that the organic hollow filler was changed to 1 part of an acrylonitrile-based hollow filler (product name: “MATSUMOTO MICROSPHERE MFL-HD30CA”, manufactured by Matsumoto Yushi-Seiyaku Co., Ltd., specific gravity=0.14, heat resistance=140° C., average particle diameter=30 μm).

### [Production Example 6]: Production of Pressure-Sensitive Adhesive Layer (6)

A pressure-sensitive adhesive layer (6) having a thickness of 100 μm was formed in the same manner as in Production Example 5 except that the amount of the organic hollow filler was changed to 5 parts.

### [Production Example 7]: Production of Pressure-Sensitive Adhesive Layer (7)

A pressure-sensitive adhesive layer (7) having a thickness of 100 μm was formed in the same manner as in Production Example 5 except that the amount of the organic hollow filler was changed to 10 parts.

### [Production Example 8]: Production of Pressure-Sensitive Adhesive Layer (8)

A pressure-sensitive adhesive layer (8) having a thickness of 100 μm was formed in the same manner as in Production Example 1 except that the organic hollow filler was changed to 1 part of an acrylonitrile-based hollow filler (product name: “MATSUMOTO MICROSPHERE MFL-100MCA”, manufactured by Matsumoto Yushi-Seiyaku Co., Ltd., specific gravity=0.12, heat resistance=155° C., average particle diameter=60 μm).

### [Production Example 9]: Production of Pressure-Sensitive Adhesive Layer (9)

A pressure-sensitive adhesive layer (9) having a thickness of 100 μm was formed in the same manner as in Production Example 8 except that the amount of the organic hollow filler was changed to 3 parts.

### [Production Example 10]: Production of Pressure-Sensitive Adhesive Layer (10)

A pressure-sensitive adhesive layer (10) having a thickness of 100 μm was formed in the same manner as in Production Example 8 except that the amount of the organic hollow filler was changed to 5 parts.

### [Production Example 11]: Production of Pressure-Sensitive Adhesive Layer (11)

A pressure-sensitive adhesive layer (11) having a thickness of 100 μm was formed in the same manner as in Production Example 1 except that the organic hollow filler was changed to 0.1 part of an acrylonitrile-based hollow filler (product name: “MATSUMOTO MICROSPHERE FN-80SDE”, manufactured by Matsumoto Yushi-Seiyaku Co., Ltd., specific gravity=0.025, heat resistance=140° C., average particle diameter=30 μm).

### [Production Example 12]: Production of Pressure-Sensitive Adhesive Layer (12)

A pressure-sensitive adhesive layer (12) having a thickness of 100 μm was formed in the same manner as in Production Example 11 except that the amount of the organic hollow filler was changed to 2 parts.

### [Production Example 13]: Production of Pressure-Sensitive Adhesive Layer (13)

A pressure-sensitive adhesive layer (13) having a thickness of 200 μm was formed in the same manner as in Production Example 1 except that: the hollow filler was not used; and the thickness of the pressure-sensitive adhesive composition after its drying was set to 200 μm.

### [Production Example 14]: Production of Pressure-Sensitive Adhesive Layer (14)

A pressure-sensitive adhesive layer (14) having a thickness of 85 μm was formed in the same manner as in Production Example 1 except that: the hollow filler was not used; and the thickness of the pressure-sensitive adhesive composition after its drying was set to 85 μm.

### Example 1

The two pressure-sensitive adhesive layer surfaces of the pressure-sensitive adhesive layers (1) obtained in Production Example 1 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (1) having a total thickness of 200 μm (construction: pressure-sensitive adhesive layer (1)/pressure-sensitive adhesive layer (1)) was obtained.

The result of the evaluation of the tape is shown in Table 1.

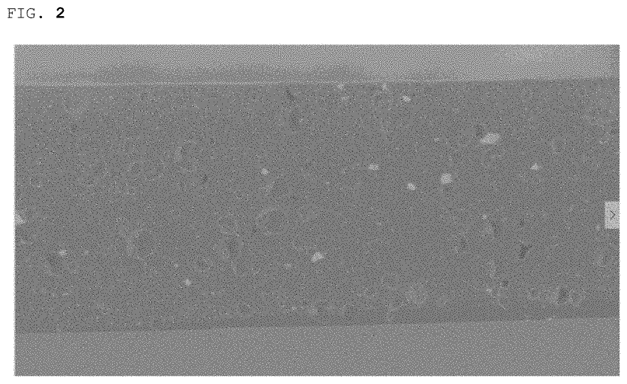

In addition, a photographic view of a section of the resultant double-sided pressure-sensitive adhesive tape (1) taken with a scanning electron microscope (S-3400N manufactured by Hitachi High-Technologies Corporation) is shown in FIG. 2.

### Example 2

The two pressure-sensitive adhesive layer surfaces of the pressure-sensitive adhesive layers (2) obtained in Production Example 2 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (2) having a total thickness of 200 μm (construction: pressure-sensitive adhesive layer (2)/pressure-sensitive adhesive layer (2)) was obtained.

The result of the evaluation of the tape is shown in Table 1.

### Example 3

The two pressure-sensitive adhesive layer surfaces of the pressure-sensitive adhesive layers (3) obtained in Production Example 3 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (3) having a total thickness of 200 μm (construction: pressure-sensitive adhesive layer (3)/pressure-sensitive adhesive layer (3)) was obtained.

The result of the evaluation of the tape is shown in Table 1.

### Example 4

The two pressure-sensitive adhesive layer surfaces of the pressure-sensitive adhesive layers (4) obtained in Production Example 4 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (4) having a total thickness of 200 μm (construction: pressure-sensitive adhesive layer (4)/pressure-sensitive adhesive layer (4)) was obtained.

The result of the evaluation of the tape is shown in Table 1.

### Example 5

The two pressure-sensitive adhesive layer surfaces of the pressure-sensitive adhesive layers (5) obtained in Production Example 5 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (5) having a total thickness of 200 μm (construction: pressure-sensitive adhesive layer (5)/pressure-sensitive adhesive layer (5)) was obtained.

The result of the evaluation of the tape is shown in Table 1.

### Example 6

The two pressure-sensitive adhesive layer surfaces of the pressure-sensitive adhesive layers (6) obtained in Production Example 6 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (6) having a total thickness of 200 μm (construction: pressure-sensitive adhesive layer (6)/pressure-sensitive adhesive layer (6)) was obtained.

The result of the evaluation of the tape is shown in Table 1.

### Example 7

The two pressure-sensitive adhesive layer surfaces of the pressure-sensitive adhesive layers (7) obtained in Production Example 7 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (7) having a total thickness of 200 μm (construction: pressure-sensitive adhesive layer (7)/pressure-sensitive adhesive layer (7)) was obtained.

The result of the evaluation of the tape is shown in Table 1.

### Example 8

The two pressure-sensitive adhesive layer surfaces of the pressure-sensitive adhesive layers (8) obtained in Production Example 8 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (8) having a total thickness of 200 μm (construction: pressure-sensitive adhesive layer (8)/pressure-sensitive adhesive layer (8)) was obtained.

The result of the evaluation of the tape is shown in Table 1.

### Example 9

The two pressure-sensitive adhesive layer surfaces of the pressure-sensitive adhesive layers (9) obtained in Production Example 9 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (9) having a total thickness of 200 μm (construction: pressure-sensitive adhesive layer (9)/pressure-sensitive adhesive layer (9)) was obtained.

The result of the evaluation of the tape is shown in Table 1.

### Example 10

The two pressure-sensitive adhesive layer surfaces of the pressure-sensitive adhesive layers (10) obtained in Production Example 10 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (10) having a total thickness of 200 μm (construction: pressure-sensitive adhesive layer (10)/pressure-sensitive adhesive layer (10)) was obtained.

The result of the evaluation of the tape is shown in Table 1.

### Example 11

The two pressure-sensitive adhesive layer surfaces of the pressure-sensitive adhesive layers (11) obtained in Production Example 11 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (11) having a total thickness of 200 μm (construction: pressure-sensitive adhesive layer (11)/pressure-sensitive adhesive layer (11)) was obtained.

The result of the evaluation of the tape is shown in Table 1.

### Example 12

The two pressure-sensitive adhesive layer surfaces of the pressure-sensitive adhesive layers (12) obtained in Production Example 12 on which the release liners were not arranged were bonded to each other. The resultant structural body was passed through a laminator (0.3 MPa, speed: 0.5 m/min) at room temperature once, and was then aged in an oven at 50° C. for 1 day. After that, the release liners were peeled off. Thus, as shown in Table 1, a double-sided pressure-sensitive adhesive tape (12) having a total thickness of 200 μm (construction: pressure-sensitive adhesive layer (12)/pressure-sensitive adhesive layer (12)) was obtained.

The result of the evaluation of the tape is shown in Table 1.

### Comparative Example 1

The release liner of the pressure-sensitive adhesive layer (16) obtained in Production Example 16 was peeled off. Thus, as shown in Table 1, a single-layer double-sided pressure-sensitive adhesive tape (C1) having a total thickness of 200 μm (construction: pressure-sensitive adhesive layer (16)) was obtained.

The result of the evaluation of the tape is shown in Table 1.

### Comparative Example 2

The release liner of the pressure-sensitive adhesive layer (17) obtained in Production Example 17 was peeled off. Thus, as shown in Table 1, a single-layer double-sided pressure-sensitive adhesive tape (C2) having a total thickness of 85 μm (construction: pressure-sensitive adhesive layer (17)) was obtained.

The result of the evaluation of the tape is shown in Table 1.

TABLE 1

| | | | Example | Example | Example | Example | Example | Example | Example |
|---|---|---|---|---|---|---|---|---|---|
| | | | 1 | 2 | 3 | 4 | 5 | 6 | 7 |
| Formu- | Monomer | Kind | BA/AA = | BA/AA = | BA/AA = | BA/AA = | BA/AA = | BA/AA = | BA/AA = |
| lation | component | | 95:5 | 95:5 | 95:5 | 95:5 | 95:5 | 95:5 | 95: 5 |
| | (m) | Part(s) by | 100 | 100 | 100 | 100 | 100 | 100 | 100 |
| | | weight | | | | | | | |
| | Tackifying | Kind | YS | YS | YS | YS | YS | YS | YS |
| | resin | | POLYSTER | POLYSTER | POLYSTER | POLYSTER | POLYSTER | POLYSTER | POLYSTER |
| | | | T-115 | T-115 | T-115 | T-115 | T-115 | T-115 | T-115 |
| | | Part(s) by | 20 | 20 | 20 | 20 | 20 | 20 | 20 |
| | | weight | | | | | | | |
| | Cross- | Kind | TETRAD- | TETRAD- | TETRAD- | TETRAD- | TETRAD- | TETRAD- | TETRAD- |
| | linking | | C | C | C | C | C | C | C |
| | agent 1 | Part(s) by | 0.02 | 0.02 | 0.02 | 0.02 | 0.02 | 0. 02 | 0. 02 |
| | | weight | | | | | | | |
| | Cross- | Kind | CORONATE | CORONATE | CORONATE | CORONATE | CORONATE | CORONATE | CORONATE |
| | linking | | L | L | L | L | L | L | L |
| | agent 2 | Part(s) by | 3 | 3 | 3 | 3 | 3 | 3 | 3 |
| | | weight | | | | | | | |
| | Additive | Kind | AT- | AT- | AT- | AT- | AT- | AT- | AT- |
| | | | DN101 | DN101 | DN101 | DN101 | DN101 | DN101 | DN101 |
| | | Part(s) by | 6 | 6 | 6 | 6 | 6 | 6 | 6 |
| | | weight | | | | | | | |
| | Hollow | Kind | AN | AN | AN | AN | AN | AN | AN |
| | filler | Part(s) by | 5 | 2 | 0.5 | 10 | 1 | 5 | 10 |
| | | weight | | | | | | | |
| | | Specific | 0.23 | 0.23 | 0.23 | 0.23 | 0.14 | 0.14 | 0.14 |
| | | gravity | | | | | | | |
| | | Heat | 130 | 130 | 130 | 130 | 140 | 140 | 140 |
| | | resistance/ | | | | | | | |
| | | ° C. | | | | | | | |
| | | Average | 20 | 20 | 20 | 20 | 30 | 30 | 30 |
| | | particle | | | | | | | |
| | | diameter/ | | | | | | | |
| | | μm | | | | | | | |
| Volume ratio of hollow | | | 22% | 9% | 2% | 43% | 7% | 36% | 71% |
| filler in pressure-sensitive | | | | | | | | | |
| adhesive | | | | | | | | | |
| Total thickness (μm) | | | 200 | 200 | 200 | 200 | 200 | 200 | 200 |
| Impact resistance (J) | | | 0. 60 | 0.70 | 0.90 | 0.60 | 0.60 | 0.85 | 0.50 |
| | | | Example | Example | Example | Example | Example | Comparative | Comparative |
| | | | 8 | 9 | 10 | 11 | 12 | Example 1 | Example 2 |
| Formu- | Monomer | Kind | BA/AA = | BA/AA = | BA/AA = | BA/AA = | BA/AA = | BA/AA= | BA/AA= |
| lation | component | | 95:5 | 95:5 | 95:5 | 95:5 | 95:5 | 95:5 | 95: 5 |
| | (m) | Part(s) by | 100 | 100 | 100 | 100 | 100 | 100 | 100 |
| | | weight | | | | | | | |
| | Tackifying | Kind | YS | YS | YS | YS | YS | YS | YS |
| | resin | | POLYSTER | POLYSTER | POLYSTER | POLYSTER | POLYSTER | POLYSTER | POLYSTER |
| | | | T-115 | T-115 | T-115 | T-115 | T-115 | T-115 | T-115 |
| | | Part(s) by | 20 | 20 | 20 | 20 | 20 | 20 | 20 |
| | | weight | | | | | | | |
| | Cross- | Kind | TETRAD- | TETRAD- | TETRAD- | TETRAD- | TETRAD- | TETRAD- | TETRAD- |
| | linking | | C | C | C | C | C | C | C |
| | agent 1 | Part(s) by | 0.02 | 0.02 | 0.02 | 0.02 | 0.02 | 0.02 | 0.02 |
| | | weight | | | | | | | |
| | Cross- | Kind | CORONATE | CORONATE | CORONATE | CORONATE | CORONATE | CORONATE | CORONATE |
| | linking | | L | L | L | L | L | L | L |
| | agent 2 | Part(s) by | 3 | 3 | 3 | 3 | 3 | 3 | 3 |
| | | weight | | | | | | | |
| | Additive | Kind | AT- | AT- | AT- | AT- | AT- | AT- | AT- |
| | | | DN101 | DN101 | DN101 | DN101 | DN101 | DN101 | DN101 |
| | | Part(s) by | 6 | 6 | 6 | 6 | 6 | 6 | 6 |
| | | weight | | | | | | | |
| | Hollow | Kind | AN | AN | AN | AN | AN | — | — |
| | filler | Part(s) by | 1 | 3 | 5 | 0.1 | 2 | — | — |
| | | weight | | | | | | | |
| | | Specific | 0.12 | 0.12 | 0.12 | 0.025 | 0.025 | — | — |
| | | gravity | | | | | | | |
| | | Heat | 155 | 155 | 155 | 140 | 140 | — | — |
| | | resistance/ | | | | | | | |
| | | ° C. | | | | | | | |
| | | Average | 60 | 60 | 60 | 30 | 30 | — | — |
| | | particle | | | | | | | |
| | | diameter/ | | | | | | | |
| | | μm | | | | | | | |

| | | | | | | | |
|---|---|---|---|---|---|---|---|
| Volume ratio of hollow | 8% | 25% | 42% | 4% | 80% | — | — |
| filler in pressure-sensitive | | | | | | | |
| adhesive | | | | | | | |
| Total thickness (μm) | 200 | 200 | 200 | 200 | 200 | 200 | 85 |
| Impact resistance (J) | 0.70 | 0.90 | 0.60 | 0.50 | 0.40 | 0.10 | 0.05 |

According to at least one embodiment of the present invention, the double-sided pressure-sensitive adhesive tape that can express excellent impact resistance can be provided.

The double-sided pressure-sensitive adhesive tape according to at least one embodiment of the present invention can be suitably used for the inside of a mobile device or the like.

What is claimed is:

1. A double-sided pressure-sensitive adhesive tape for use in fixing a member to be included in a mobile device,
the double-sided pressure-sensitive adhesive tape comprising a pressure-sensitive adhesive layer,
wherein the pressure-sensitive adhesive layer is formed from a pressure-sensitive adhesive composition, and
wherein the pressure-sensitive adhesive composition contains an organic hollow filler.

2. The double-sided pressure-sensitive adhesive tape according to claim 1, wherein the organic hollow filler has a specific gravity of from 0.01 to 1.2.

3. The double-sided pressure-sensitive adhesive tape according to claim 1, wherein the organic hollow filler has an average particle diameter of from 5 μm to 70 μm.

4. The double-sided pressure-sensitive adhesive tape according to claim 3, wherein the organic hollow filler is an acrylonitrile-based hollow filler.

5. The double-sided pressure-sensitive adhesive tape according to claim 1, wherein the double-sided pressure-sensitive adhesive tape has a thickness of 100 μm or more.

6. The double-sided pressure-sensitive adhesive tape according to claim 1, wherein the pressure-sensitive adhesive composition contains at least one kind selected from a monomer component (m) and a polymer component (P) obtained by polymerizing the monomer component (m), and the monomer component (m) contains an alkyl (meth)acrylate having an alkyl group having 4 to 18 carbon atoms at an ester terminal thereof.

7. The double-sided pressure-sensitive adhesive tape according to claim 6, wherein a content of the alkyl (meth)acrylate having an alkyl group having 4 to 18 carbon atoms at an ester terminal thereof in the monomer component (m) is from 50 wt % to 100 wt %.

8. The double-sided pressure-sensitive adhesive tape according to claim 1, wherein the double-sided pressure-sensitive adhesive tape is used in fixing one of a display portion and a display portion-protecting member with respect to a housing in the mobile device.
